(19) United States
(12) Patent Application Publication
(10) Pub. No.: US 2014/0257978 A1
(43) Pub. Date: Sep. 11, 2014

(54) AUTOMATED FINANCING FOR OFFER PRESENTATIONS

(71) Applicant: HYPEKICK, INC., Provo, UT (US)

(72) Inventor: Matthew Jeremy Bills, Provo, UT (US)

(73) Assignee: HYPEKICK, INC., Provo, UT (US)

(21) Appl. No.: 13/842,223

(22) Filed: Mar. 15, 2013

Related U.S. Application Data
(60) Provisional application No. 61/774,590, filed on Mar. 8, 2013.

(51) Int. Cl. G06Q 30/02

(52) U.S. Cl. CPC G06Q 30/0255
USPC 705/14.53

(57) ABSTRACT

Systems and methods offer deal platforms based on timely purchasing trends for specific consumers and immediate availability of financial resources to specific consumers. One method presents a combined promotional and financing offer to a potential purchaser. Another method offers predicted goods and/or services for a potential purchaser. Another method provides a personal loan for purchases from specific providers. Another method presents a consumer-specific deal portal to a potential consumer. Additional methods are also described.

### CROSS-REFERENCE TO RELATED APPLICATIONS

This application claims the benefit of priority of U.S. Provisional 61/774,590, filed Mar. 8, 2013, and entitled “Automated Financing for Offer Presentations,” which is incorporated herein in its entirety.

### BACKGROUND

There are many options for consumers to take advantage of deals and advertising offers in commercial transactions. Over the past few years, deal websites have offered consumers many types of potential deals such as limited-time offers, limited quantity deals, bulk quantity deals, local deals, and so forth.

Many of these website businesses rely on the ability to recruit advertisers to offer products or services at discount rates in order to attract purchasers for those deals. Additionally, the website business may try to identify target consumer groups to which they might advertise in order to recruit advertisers. However, many of the recruited advertisers have found that their efforts of increasing their ongoing customer base are not being satisfied. Instead, many of the discount purchasers are not repeat customers, and the advertisers often end up losing money invested in the discount offerings without gaining any sizable increase in ongoing or loyal customer base.

Additionally, discount websites are typically limited to product and service offerings that are relatively small in terms of cost to the consumers. This is due in part to the nature of discount buyers who are often unwilling to spend large sums of money on what typically constitute impulse purchases. Since the deal companies try to reach a very broad consumer base, the advertisers can experience difficulty in specifically targeting potential consumers who might have a timely interest in a particular type of goods or services. As single-purchase amounts increase for specific deals, the level of specificity required to properly target potential consumers also typically increases, but deal websites often cannot offer that required level of specificity simply because the deal websites do not have access to timely consumption trends for specific users or potential customers.

Further, the ability to offer deals that require a large purchase commitment is often limited by the ability of potential consumers to readily spend large amounts of money on impulse purchases. Credit cards offer some availability to immediate consumer credit, but often require relatively high interest rates and other expensive fees that deter some consumers from finalizing a purchase using credit card funding. Instead, many potential consumers rely on some amount of planning, for example, through cash savings, credit rehabilitation, or financial institution financing, in order to make large purchases. This type of planning often inhibits large-scale impulse purchases. Hence, this type of planning can inhibit many consumers from taking advantage of deals that require a large financial commitment. This, in turn, reinforces existing business models of deal websites to limit deal offers to relatively small purchase amounts so that deals that are readily within the financial constraints of a broad consumer base.

### SUMMARY

Embodiments described herein take advantage of the convergence of online deals, timely purchasing trends for specific consumers, and immediate availability of financial resources to specific consumers. Financial institutions are in a unique position to evaluate a customer's financial purchase history and credit worthiness on a frequent basis. This position allows financial institutions to provide valuable deal offers to specific individuals that otherwise would not be available at all, or would not be readily accessible to, those specific consumers. The deal offers may be customized to a consumers recent purchase history, thus making the deals highly relevant to the types of purchases that the consumers are interested in at the time the deal is offered to the consumer. The deal offers also may be presented with available financing options that are customized to a consumers credit history. By offering deal financing options customized for specific consumers, consumers can have access to a much broader range of deals for goods and services that conventionally would not be made available to the consumer under more generic advertising business models. Additionally, financial institutions can offer highly secure deal portals to their customers in connection with existing account login web services. The alignment of these features presents financial institutions with very unique opportunities to bring a high level of additional value to their customers' purchasing options for more deals and for deals that provide increased savings for the customers.

In one embodiment, a method for presenting a combined promotional and financing offer to a potential purchaser is described. An embodiment of the method includes identifying a promotional offer for a potential purchaser based on a purchase history of the potential purchaser. The method also includes customizing a financing offer for the promotional offer to the potential purchaser based on a financial history of the potential purchaser. The method also includes presenting the customized financing offer with the promotional offer to the potential purchaser. Other embodiments of the method are also described.

In another embodiments, a method for offering predicted goods and/or services for a potential purchaser is described. An embodiment of the method includes using a financial customer's financial history (purchase history, credit history, etc.) to predict a future purchase of specific goods/services. The method also includes obtaining pre-approval for an amount of financing commensurate with the predicted future purchase. The method also includes presenting an unsolicited offer to the financial customer to purchase the specific goods/services using the pre-approved financing. Other embodiments of the method are also described.

In another embodiment, a method for providing a personal loan for purchases from specific providers is described. An embodiment of the method includes identifying a class of goods/services in a purchase history of a consumer. The method also includes pre-approving at least one third-party provider of good/services within the identified class of goods/services. The method also includes offering a financial loan to the consumer for use in one or more purchases of goods/services from the pre-approved third party provider(s). Other embodiments of the method are also described.

In another embodiment, a method for presenting a consumer-specific deal portal to a potential consumer is provided. An embodiment of the method includes generating a deal portal for a consumer. The method also includes filtering a plurality of deals to identify a subset of deals for presentation to the consumer based the consumer's purchase history. The method also includes presenting the deals to the consumer in the deal portal. The method also includes presenting pre-approved financing terms to the consumer for at least one of the subset of deals presented in the deal portal. Other embodiments of the method are also described.

Systems, apparatuses, computer program products, and other implementations of these methods are also described herein to offer various physical embodiments by which each of these and other similar methods may be carried out by one or more entities.

### BRIEF DESCRIPTION OF THE DRAWINGS

FIG. 1 depicts a schematic diagram of one embodiment of a system for presenting offers and financing to a user.

FIG. 2 depicts a schematic diagram of one embodiment of a user interface with a deal portal to present consumer-specific deals to a potential purchaser.

FIG. 3 depicts a schematic diagram of another embodiment of a user interface with a deal portal that includes a financing option for a particular offer to the potential purchaser.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

Many of the functional units described in this specification have been labeled as modules, or equivalent functional units, in order to more particularly emphasize their implementation independence. Modules are at least partially implemented in hardware, in one form or another. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented using software, stored on a physical storage device (e.g., a computer readable storage medium), for execution by various types of processors. Reference to a computer readable storage medium may take any physical form capable of storing machine-readable instructions, at least for a time in a non-transient state, on a digital processing apparatus. Examples of a computer readable storage medium include, but are not limited to, a semiconductor or solid state memory, magnetic tape, a removable computer diskette, a random access memory (RAM), a read-only memory (ROM), a Bernoulli drive, ARDUINO, a magnetic disk, flash memory, integrated circuits, or other digital processing apparatus memory device, and an optical disk. Current examples of optical disks include a compact disk with read only memory (CD-ROM), a compact disk with read/write (CD-R/W), and a digital video disk (DVD).

An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several storage or memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more physical devices which are referred to herein as computer readable media and/or electronic data storage devices.

In some configurations, the software portions are stored in a non-transitory state such that the software portions, or representations thereof, persist in the same physical location for a period of time. Additionally, in some configurations the software portions are stored on one or more non-transitory storage devices, which include hardware elements capable of storing non-transitory states and/or signals representative of the software portions, even though other portions of the non-transitory storage devices may be capable of altering and/or transmitting the signals. One example of a non-transitory storage device includes a read-only memory (ROM) which can store signals and/or states representative of the software portions for a period of time. However, the ability to store the signals and/or states is not diminished by further functionality of transmitting signals that are the same as or representative of the stored signals and/or states. For example, a processor may access the ROM to obtain signals that are representative of the stored signals and/or states in order to execute the corresponding software instructions.

Reference throughout this specification to “one embodiment,” “one configuration,” “an embodiment,” “a configuration,” or similar language means that a particular feature, structure, or characteristic described in connection with the embodiment or configuration is included in at least one embodiment or configuration discussed in the present disclosure. Thus, references to a particular embodiment or configuration, and similar language, throughout this specification may, but do not necessarily, refer to the same configuration.

Furthermore, the described features, structures, or characteristics of configurations of the invention may be combined in any suitable manner in one or more configurations. In the following description, numerous specific details are provided, such as examples of programming, software modules (stored on a physical device), user selections, network transactions, database queries, database structures, hardware modules, hardware circuits, hardware chips, etc., to provide a thorough understanding of configurations of the invention. One skilled in the relevant art will recognize, however, that configurations of the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled operations are indicative of one configuration of the presented method. Other operations and methods may be conceived that are equivalent in function, logic, or effect to one or more operations, or portions thereof, of the illustrated method. Additionally, the format and symbols employed are provided to explain the logical operations of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated operations of the depicted method. Additionally, the order in which a particular method occurs may or may not strictly adhere to the order of the corresponding operations shown.

Although the operations of the methods herein are shown and described in a particular order, the order of the operations of each method may be altered so that certain operations may be performed in an inverse order or so that certain operations may be performed, at least in part, concurrently with other operations. In another configuration, instructions or sub-operations of distinct operations may be implemented in an intermittent and/or alternating manner.

While many embodiments are described herein, at least some of the described embodiments relate to a system and method for presenting combined promotional/financing offers to a user. In one embodiment, the system and method implement operations to identify a promotional offer for a potential purchaser. The promotional offer may be identified based on a purchase history of the potential purchaser. The purchase history may be a log of past purchases from a single source (i.e., provider of goods or services) or may be accumulated from a variety of sources. In one embodiment, the entity that presents the promotional/financing offers to the potential purchaser is different from the source(s) of the past purchase(s). The operations also include customizing a financing offer for the promotional offer to the potential purchaser based on a financial history of the potential purchaser. In some embodiments, the financing offer is specific to a particular combination of the goods/service offered to the potential purchaser and the financial history of the potential purchaser. The operations also include presenting the customized financing offer with the promotional offer to the potential purchaser. In a further embodiment, the operations also include presenting the offers to the potential purchaser within a secure account web portal associated with the potential purchaser. The web portal may be secured by any type of security mechanisms commonly used in internet and online transactions, including encryption, authentication, passwords, and so forth. In another embodiment, the operations also include presenting each offer to the potential purchaser in association with a related past purchase. For example, each offer for a particular type of goods/services may be presented to the user within the context of a statement or log of past purchases from the same source or similar types of sources, of the same goods/services or similar type of goods/services, and so forth. In another example, the offer may be categorized with past purchases that are about the same amount in terms of total purchase price, financing costs, periodic payment amounts, and so forth. In another embodiment, the operations also include presenting a one-click purchase option to the potential purchaser to finalize a purchase transaction for a personalized transaction which includes the promotional offer and the customized financing offer.

Another embodiment of the system and method implements operations to present financing for predicted goods/services to a potential purchaser. The predicted goods/services may be presented in a promotional offer with special pricing and/or financing or in a non-promotional offer with typical pricing (with or without financing. The operations include using a financial customer's financial history (purchase history, credit history, etc.) to predict a future purchase of specific goods/services. In one embodiment, the prediction is based (solely, primarily, or in combination with other factors) on categorical types of goods/services previously purchased by the potential purchaser. These goods/services may be categorized by the types of goods/services previously purchased, by the purchase amount of the goods/services previously purchased, by the financing terms of the goods/services previously financed, and so forth. The operations also include obtaining pre-approval for an amount of financing commensurate with the predicted future purchase. In one embodiment, the pre-approval is an automated process that is handled internally by the entity presenting the financing to the potential purchaser or, alternatively, by a separate financing processor. In either case, the financing may depend on the financial status of the potential purchaser at the time the offer is presented to the potential purchaser. The operations also include presenting an unsolicited offer to the financial customer to purchase the specific goods/services using the pre-approved financing. It should be noted that this type of pre-approved financing may differ from conventional types of pre-approval processes which require additional information from or actions by the potential purchaser to finalize the terms of the pre-approved financing. In some embodiments, the offer presented to the potential purchaser is presented by the lender directly to the potential purchaser (e.g., as an existing customer of the lender), so the lender has the ability to fully finalize the pre-approval status of the financing terms prior to extending the corresponding offer to the potential purchaser. In a further embodiment, the operations also include obtaining the pre-approval by providing the financial customer's profile information to a third party approval service (e.g., a financing processor) and receiving an approval from the third party approval service. In a further embodiment, the operations also include predicting the future purchase based on a combination of purchase types, purchase amounts, purchase timing, etc.

Another embodiment of the system and method implements operations to provide a personal loan to a potential purchaser for purchases from one or more specific providers of goods/services. The operations include identifying a class of goods/services in a purchase history of a consumer. The class of goods/services may be categorized based on any single factor or combination of factors such as intended use, type of goods, type of services, purchase amount, and so forth. The operations also include pre-approving at least one third-party provider of good/services within the identified class of goods/services. The third-party provider is pre-approved in terms of allowing the potential purchaser to purchase goods/services from the third-party provider using some form of credit or financing from the lender, who is distinct from the third-party provider. The operations also include offering a financial loan to the consumer for use in one or more purchases of goods/services from the pre-approved third party provider(s). This type of loan may be referred to, in some contexts, as a personal loan. However, within the context of the present description, this type of personal loan is not necessarily available to the potential purchaser except for offers presented to the potential purchaser by the lender for goods/services from the third-party provider(s). In a further embodiment, the operations also include presenting the offer within the context of a prior purchase within a visual display of the consumer's purchase history.

Another embodiment of the system and method implements operations to facilitate a consumer-specific deal portal. The operations include generating a deal portal for a consumer, filtering a plurality of deals to identify a subset of deals for presentation to the consumer based the consumer's purchase history, presenting the deals to the consumer in the deal portal, and presenting pre-approved financing terms to the consumer for at least one of the subset of deals presented in the deal portal. In a further embodiment, the operations also include presenting a one-click purchase option to the potential purchases to finalize a purchase transaction for a deal within the deal portal at the financing terms associated with that deal.

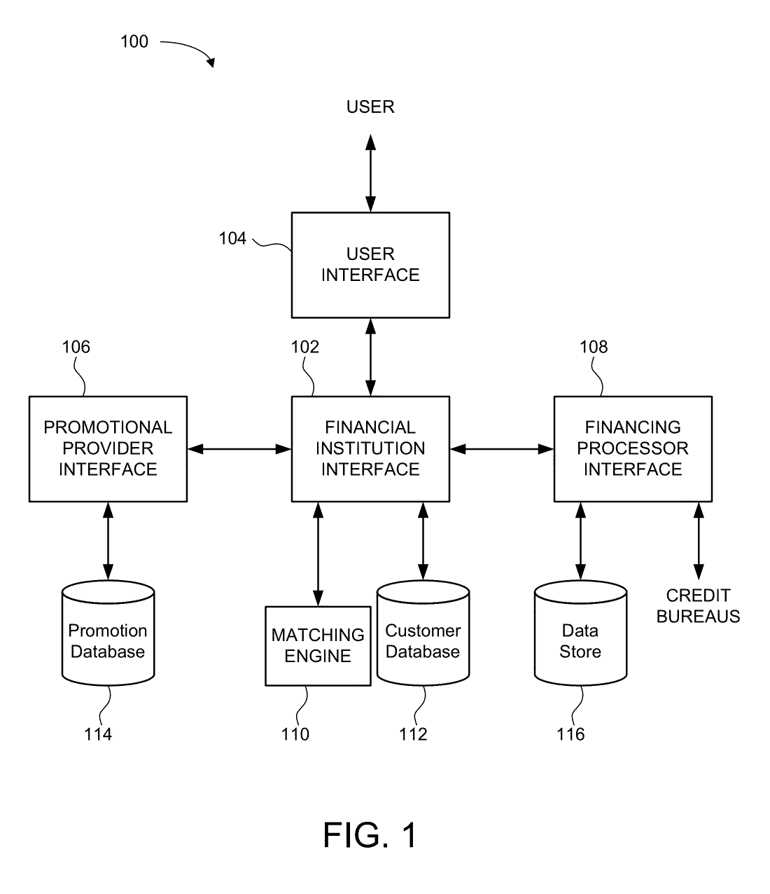

FIG. 1 depicts a schematic diagram of one embodiment of a system 100 for presenting offers and financing to a user. The illustrated system 100 includes a financial institution interface 102, a user interface 104, a promotional provider interface 106, a financing processor interface 108, and a matching engine 110. Although the system 100 is shown and described with certain components and functionality, other embodiments of the system 100 may include fewer or more components to implement less or more functionality.

In general, the financial institution interface 102 allows a financial institution to manage the processes associated with presenting goods/services offers and corresponding financing offers to customers. For convenience, the customers are also referred to herein as users. In one embodiment, the financial institution interface 102 interfaces with the promotional provider interface 106 and the financing processor interface 108 to manage which offers are presented (or not presented) to particular users, as well as which type of financing (if any) is offered in conjunction with the goods/services.

In one embodiment, each of the interfaces described herein is implemented in a computer application that is accessible to the corresponding entity or personnel. In a more specific embodiment, one or more of the interfaces is implemented in an online application (i.e., a web app) that is accessible via the internet. Secured access to each of these interfaces may be governed by individual access privileges using appropriate security techniques (e.g., encryption, authentication, etc.).

In some embodiments, the financial institution interface 102 is coupled to a customer database 112. The customer database 112 may include any information pertinent to the customers, either individually or as demographic or commercial segments. Typical customer data includes, but is not limited to, names, addresses, transaction histories, financing histories, and so forth.

As used herein, the term coupled (and similar terms) refers to an indirect or direct communication channel between the designated components. The communication channel may be via wired and/or wireless transmission media and may utilize connections via the internet or any other type of networked environment.

Additionally, the reference to a database or other data storage device and/or structure does not necessitate a single device or structure. A database or data storage device/structure may be implemented on more than one device (e.g., in a distributed environment) and/or in multiple data structures.

In some embodiments, the promotional provider interface 106 facilitates entry of promotional offers that are available from a particular source (e.g., seller or merchant of goods/services). Using the promotional provider interface 106, a provider may enter one or multiple offers which may be made available to the users via the user interface 104. In some embodiments, a promotion database 114 coupled to the promotional provider interface stores the offer(s) from each provider. There is no inherent limit on the number of offers from a particular provider or the number sellers/merchants that may be stored in the promotion database 114.

In some embodiments, the financing processor interface 108 facilitates third-party processing of financing transactions. Although the financial institution may perform its own financing processing, in some situations the financial institution may elect to outsource the financing processing to another entity. For example, the financial institution may outsource the financing processing, or at least portions of the financing processing, to an organization that operates a loan origination platform to review and make automated or semi-automated decisions regarding tentative financing arrangements. As part of the financing processing, the entity performing the financing processing may interface with one or more credit bureaus to obtain credit scores for a potential financing participant (e.g., a potential purchaser). Additionally, the financing processor interface 108 may be coupled to a data store 116 to store information related to a particular person, transaction, or other aspect of a financing transaction.

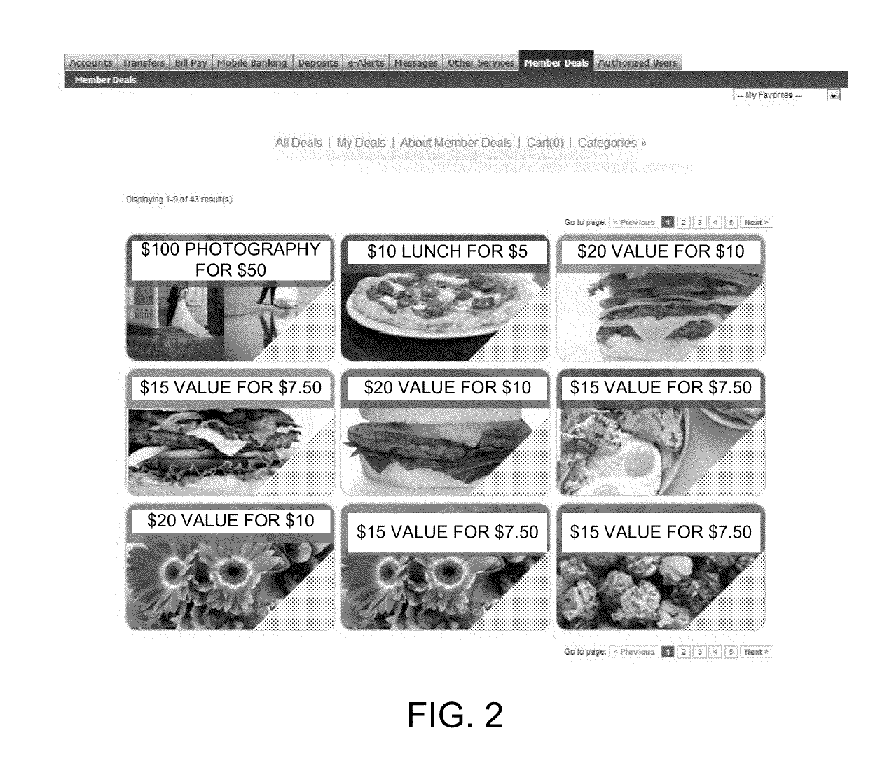

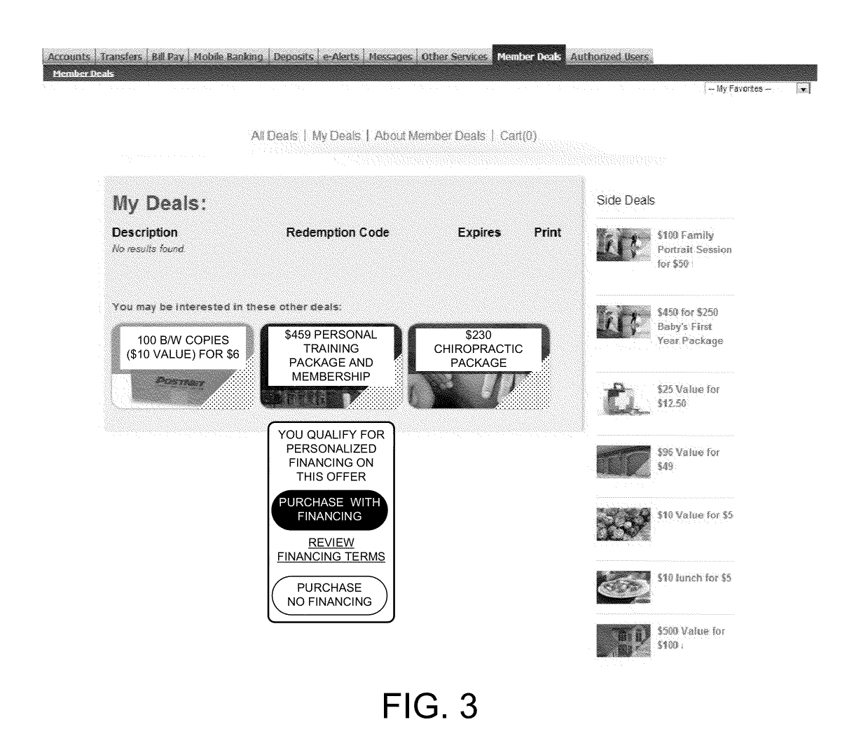

Once the promotional offers are provided by the goods/service providers, and corresponding financing options are established, for example, by the financing processor, the financial institution interface 102 facilitates presentation of the offers/financing to specific users via the user interface 104. FIGS. 2 and 3 illustrate examples of embodiments of the user interface 104.

The matching engine 110 is coupled to the financial institution interface 102 to allow the financial institution to determine which offers (if any) to present to a particular user and what financing (if any) to present in combination with each offer. In general, matching algorithms used by the matching engine 110 may look at a variety of factors in determining how to match an offer and financing to a particular user. Some factors include, but are not limited to, the purchase history of a user, the payment history of a user, the transaction activity (e.g., frequency of transactions, debit-to-credit ratios for a particular account, and so forth), of a user, the balance of a particular account of the user, and other similar factors.

FIG. 2 depicts a schematic diagram of one embodiment of user interface 104 with a deal portal to present consumer-specific deals to a potential purchaser. In the illustrated embodiment, the deal portal is presented to the potential purchaser within the context of a secured account portal for a particular financial institution. However, in other embodiments, the deal portal may be presented to the potential purchaser outside of the context of the user's secured account access. Additionally, the format of the deal portal is not limited to a particular form factor. Embodiments of the deal portal may be presented to the user via a desktop graphical display, a mobile phone display, a tablet display, or in any other visual or other communication medium sufficient to communicate the pertinent terms of the offer and financing to the user.

In the illustrated embodiment, the deal portal uses separate tiles to present graphical representations of the individual deals to the user. For each tile, the basic terms of the offer are identified. In further embodiments, the provider of the goods/services may be identified, contact information may be provided, or any other pertinent information may be conveyed as part of, or in combination with, the graphical elements for a particular offer.

FIG. 3 depicts a schematic diagram of another embodiment of a user interface 104 with a deal portal that includes a financing option for a particular offer to the potential purchaser. In the illustrated embodiment, a separate graphical element is presented near the deal for which the financing offer is available. In other embodiments, the financing notification or terms may be included in the tile or other graphical element displayed to the user. In some embodiments, the format of the presentation of offers and the corresponding financing to a particular user is not limited to a specific layout or arrangement.

In the illustrated embodiment, the graphical elements include two selection buttons and one link. The link allows the user to access more specific terms of the financing offer. The buttons allow the user to make the purchase transactions, either with or without the financing offer. In some embodiments, the selection of a button is, by itself, sufficient to execute the purchase transaction because the financial institution already has sufficient information from the user to process the transaction. For example, if the financing offer is not selected, then the financial institution may verify the availability of funds and perform any debit transactions to allow the user to pay for the selected offer. If the financing offer is available and selected by the user then, in some embodiments, the user's selection is sufficient to perform a one-click finalization of the combined purchase transaction and the financing transaction. Corresponding processing within the user's associated account then may be performed to show this transaction and any associated payments made, or payments due, in the user's account.

Although not necessarily illustrated in FIGS. 1-3, additional embodiments are contemplated to implement additional functionality. In one embodiment, the system described herein is configured to present a plurality of advertisements from third-party providers, or merchants, to members of a financial institution. These offers may be referred to as promotional offers, offers, merchant offers, and so forth. Although some of these offers may be promotional, in the sense that a discount or additional perk is offered that is not typically offered with the advertised goods/services, the references herein to promotional offers may apply to any type of offer for goods/services, to a potential purchaser.

In some embodiments, the group of potential purchasers is limited to a group of members of a particular organization. The members may be defined as participants in a particular organization or, alternatively, may have some defined relationship with a particular organization. In some embodiments, all of the potential purchasers are members of a specific financial institution. In other embodiments, all of the potential purchasers are members of a defined set of financial institutions. In further embodiments, some or all of the potential purchasers may be members of an organization in another segment of the financial services industry. In further embodiments, some or all of the potential purchasers may be members of an organization outside of the financial services industry.

By utilizing a group of potential purchasers for which a financial institution (or other organization managing the offer process) has ready access to detailed historical financial information of the members, purchase transactions can be more easily facilitated for the benefit of the individual members. For example, the members can be presented with fewer offers that are more directly related to the past actions of each member. In other words, the financial institution may pre-filter the offers of goods/services as well as financing for a specific user, thus precluding presentation of offers that are not determined to be of relatively high interest to the user. In other embodiments, another entity may perform the filtering operations on behalf of the financial institution or other offering entity.

In some embodiments, presenting offers to users within the context of a banking or financial services environment allows potential purchasers to have a relatively high level of confidence in the transactions, goods/services, and companies that are associated with each offer. As banks, credit unions, and other financial institutions are prone to maintain high levels of trust by consumers, potential purchasers may find additional comfort in purchases which are presented or endorsed by the financial institution whose services they already use. Additionally, consumers can be confident that the internal transactions of the financial institution are more likely to be secure than other transactions over the internet with unknown merchants or with merchants in commercial areas that traditionally suffer from lower levels of trust.

In some embodiments, offers are presented to users in a specific deal portal or virtual shopping area of a banking environment (e.g., website or application). In other embodiments, individual offers, or smaller groups of offers, may be presented to users in other areas of a financial institution's website or electronic communications (e.g., text messaging, instant chat messaging, emails, etc.). In this way, even one-time offers presented to a user, for example, on the home page of a financial institution's website may be customized to a particular user. The user may be identified by signing into an account on the website. Alternatively, the user may be identified by the use of cookies or other electronic identification techniques that allow a user to know or anticipate which user (or subset of users) are accessing the website from a particular IP address, computer, smart phone, or other distinct location.

In a further embodiment, the system described herein is configured to present a merchant offer (promotional or non-promotional) coupled with a customized financing offer from the financial institution specifically for the user. The financing offer may be a full financing offer or a partial financing offer. A full financing offer refers to an purchase transaction for which the financial institution (or other lending source) provides credit to the purchaser for the entire amount of the purchase. A partial financing offer refers to a purchase transaction for which the financial institution (or other lending source) provides credit to the purchaser for less than the entire amount of the purchase. In this scenario, the remaining amount of the purchase transaction may be covered by a debit from the purchasers checking or savings account.

In some embodiments, users may specify preferences for which types of offers are presented to the user, how often they are presented, where they are presented, how much financing might be offered, types of financing offer, and so forth. Additionally, in some embodiments, the financial institution may monitor a user's activity to identify trends in viewing and purchasing activities of the user in order to more successfully present offers to the user that the user does or might find interested and useful.

In some embodiments, the financial institution may provide a financing offer that is a derivation of a total amount that a user qualifies for. The financial institution may establish guidelines or limits for how the financing may be used. For example, the financing terms may constrain the user to spend/use the financing in a particular combination of purchases towards the offers by third-party merchants within the within a virtual shopping area within a financial institution's environment.

In some embodiments, the user interface 104 may allow the user to filter offers based on the type of financing that is available. For example, the user may sort goods/services offers by financing terms such as periodic payments, down payments, or other terms common to financing approaches.

In some embodiments, the financial institution may combine the amount of financing that it is willing to offer to a user with another amount of financing that a merchant is willing to offer the same user. In this scenario, the financial institution may perform all financial processing internally so the user is presented with a single financing offer, even though the offer may result from a combination of two or more financing offers from different institutions or entities.

In some embodiments, the system is configured to present a pre-analyzed/approved amount for an offer for a loan/credit by a financial institution that can be used only towards purchase of a particular offer within an exclusive time period and/or virtual shopping area within a banking environment. By constraining the timing and types of purchases that might be made with an amount of proceeds from a loan/credit, the risk associated with a particular financing offer may be reduced, minimized, or otherwise controlled.

In some embodiments, a transaction table (not shown) may be analyzed in order to generate a cookie that is based on the probability or affinity of that particular user to purchase a particular item, purchase an item from a particular category or items, purchase an item from a particular merchant, or purchase an item from a particular category of merchants. These types of cookies may be sold or marketed to merchants in order to provide meaningful matches between users, offers, and financing offers.

In some embodiments, the system is configured to utilize predictive analytics in order to identify new customers that might buy from existing or new merchants. Filters and other conventional technology may be utilized in these types of analytics. In some embodiments, a user may be tagged as a result of identification through such predictive analytics.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A method for presenting a combined promotional and financing offer to a potential purchaser, the method comprising:
identifying a promotional offer for a potential purchaser based on a purchase history of the potential purchaser;
customizing a financing offer for the promotional offer to the potential purchaser based on a financial history of the potential purchaser; and
presenting the customized financing offer with the promotional offer to the potential purchaser.

2. The method of claim 1, further comprising presenting the offers to the potential purchaser within a secure account web portal associated with the potential purchaser.

3. The method of claim 1, further comprising presenting each offer to the potential purchaser in association with a related past purchase (based on type of goods/services, based on amount of purchase, etc.).

4. The method of claim 1, further comprising presenting a one-click purchase option to the potential purchaser to finalize a purchase transaction for the promotional offer and the customized financing offer.

5. A method for predicted goods and/or services for a potential purchaser, the method comprising:
using a financial customer's financial history (purchase history, credit history, etc.) to predict a future purchase of specific goods/services;
obtaining pre-approval for an amount of financing commensurate with the predicted future purchase; and
presenting an unsolicited offer to the financial customer to purchase the specific goods/services using the pre-approved financing.

6. The method of claim 5, further comprising obtaining pre-approval by providing the financial customer's profile information to a third party approval service and receiving an approval from the third party approval service.

7. The method of claim 5, further comprising predicting the future purchase based on a combination of purchase types, purchase amounts, purchase timing, etc.

8. A method for providing a personal loan for purchases from specific providers, the method comprising:
identifying a class of goods/services in a purchase history of a consumer;
pre-approving at least one third-party provider of good/services within the identified class of goods/services; and
offering a financial loan to the consumer for use in one or more purchases of goods/services from the pre-approved third party provider(s).

9. The method of claim 8, further comprising presenting the offer within the context of a prior purchase within a visual display of the consumer's purchase history.

10. A method for presenting a consumer-specific deal portal to a potential consumer, the method comprising:
generating a deal portal for a consumer;
filtering a plurality of deals to identify a subset of deals for presentation to the consumer based the consumer's purchase history;
presenting the deals to the consumer in the deal portal; and
presenting pre-approved financing terms to the consumer for at least one of the subset of deals presented in the deal portal.

11. The method of claim 10, further comprising presenting a one-click purchase option to the potential purchases to finalize a purchase transaction for a deal within the deal portal at the financing terms associated with that deal.
